(19) United States
(12) Patent Application Publication
(10) Pub. No.: US 2008/0024652 A1
(43) Pub. Date: Jan. 31, 2008

(54) ELECTRO-OPTICAL DEVICE, IMAGE PROCESSING CIRCUIT, AND ELECTRONIC DEVICE

(75) Inventor: Toru AOKI, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/769,498

(22) Filed: Jun. 27, 2007

(30) Foreign Application Priority Data
Jul. 25, 2006 (JP) 2006-201665

(51) Int. Cl. H04N 5/225

(52) U.S. Cl. 348/361; 348/E05.022; 348/E05.024; 348/E05.025

(57) ABSTRACT

An electro-optical device in which an image to be projected on a projection surface as a projection image having a size changed by a display device is displayed on a display area on the basis of input image data includes a first input image correction circuit generating first correction data which is used for reducing color non-uniformity of the projection image that occurs due to the size change on the basis of the size of the projection image using first reference correction data and correcting the input image data using the generated first correction data and a second input image correction circuit correcting the corrected input image data on the basis of a plurality of second reference correction data corresponding to a plurality of specific levels among levels that the input image data can have and set for a plurality of sets of reference coordinates in the display area for reducing the color non-uniformity.

### CROSS-REFERENCE TO RELATED APPLICATION

This application claims priority from Japanese Patent Application No. 2006-201665 filed in the Japanese Patent Office on Jul. 25, 2006, the entire disclosure of which is hereby incorporated by reference in its entirety.

### BACKGROUND

1. Technical Field

The present invention relates to a technical field of electronic devices such as an electro-optical device that is, for example, used as a light valve of a liquid crystal projector capable of reducing color non-uniformity, an image processing circuit included in the electro-optical device, an image processing method, and a projector having three light valves.

2. Related Art

An active matrix-type liquid crystal display device as an example of the electro-optical device mainly includes a liquid crystal panel, an image signal processing circuit, and a timing generating circuit. The liquid crystal panel included in the liquid crystal device has a configuration in which a liquid crystal is sandwiched between a pair of substrates, to be more specific, a configuration in which a plurality of scanning lines and a plurality of data lines are arranged so as to intersect on one of the substrates with insulation therebetween maintained and pairs of a thin-film transistor (hereinafter, referred to as a TFT) that is a kind of switching element and a pixel electrode are arranged at positions corresponding to the intersections of the scanning lines and data lines, and opposite transparent electrodes (common electrodes) facing the pixel electrodes are arranged on the other substrate with a predetermined voltage level maintained.

In liquid crystal panels, non-uniformity of luminance occurs in a display area of the liquid crystal panel due to non-uniform depths of liquid crystal layers or irregular operation characteristics of the TFTs on a surface. When a liquid crystal display including a liquid crystal panel is used as a light valve of an RGB three-panel-type projector, there is a problem that a projection image projected onto a projection surface such as a screen has non-uniformity of colors due to the non-uniform luminance of the light valves. An example of technology for reducing the non-uniformity of colors in the projection image is disclosed in JP-A-2001-343954.

A projector including this kind of electro-optical device can project an image displayed in a display area of the electro-optical device on a projection surface such as a screen on an enlarged or reduced scale by using the magnifying and telescopic functions of an optical system including a lens.

However, according to the technology disclosed in JP-A-2001-343954, only the luminance non-uniformity in a display area of an electro-optical device can be reduced, and, for example, it is difficult to sufficiently reduce the color non-uniformity of a projection image that occurs due to the optical characteristics of an optical system including a lens.

In addition, when various data for reducing the luminance non-uniformity in the display area of the electro-optical device and various data for reducing the color non-uniformity of a projection image occurring on the basis of the zoom amount of a lens are stored in a memory device together, the occupied memory capacity increases, and accordingly, this is not advantageous in terms of cost and circuit design. Moreover, it is difficult to reduce the color non-uniformity of a projection image in accordance with the zoom amount at a high speed.

### SUMMARY

Exemplary embodiments include an electro-optical device, an image processing circuit, an image processing method, and an electronic device such as a projector including the electro-optical device which are capable of reducing the color non-uniformity of a projection image at a high speed without having to increase the capacity of a memory device for storing various data for the reduction of color non-uniformity.

According to a first exemplary embodiment, there is provided an electro-optical device in which an image to be projected on a projection surface as a projection image having a size changed by a display device is displayed in a display area on the basis of input image data. The electro-optical device includes a first input image correction circuit generating first correction data which is used for reducing color non-uniformity of the projection image that occurs due to the size change on the basis of the size of the projection image using first reference correction data and correcting the input image data using the generated first correction data, and a second input image correction circuit correcting the corrected input image data on the basis of a plurality of second reference correction data corresponding to a plurality of specific levels among levels that the input image data can have and set for a plurality of sets of reference coordinates in the display area for reducing the color non-uniformity.

The electro-optical device according to the first exemplary embodiment, for example, is a liquid crystal display used as a light valve of a projection-type display device such as a projector capable of displaying a projection image projected on a projection surface such as a screen on an enlarged or reduced scale by using magnifying and telescopic function of an optical system such as a lens. In the display area of the liquid crystal display, an image is displayed on the basis of input image data input to the device. The image displayed in the display area is projected to a screen or the like as a projection image through the above-described optical system.

The first input image correction circuit, for example, is provided in a stage prior to the second input image correction circuit and generates the first correction data for reducing the color non-uniformity of the projection image occurred by the change in the size of the projection image. Since the first input image correction circuit generates the first correction data on the basis of the size of the projection image, the first correction data can be generated at a speed higher than that of the various signal processing performed by the second input image correction circuit. To be more specific, since the first input image correction circuit uses the size of a projection image as a reference value for the generation of the first correction data, the number of kinds of reference values is smaller than that in a case where both the plurality of reference coordinates in the display area and the level of input image data are used as reference values. Accordingly, since the number of the reference values is small, the color non-uniformity of the projection image can be reduced at a high speed.

In addition, since the color non-uniformity of the projection image due to optical characteristics of an optical system such as a lens can be reduced, the color non-uniformity of the projection image which cannot be sufficiently reduced only by the reduction of the luminance non-uniformity can be reduced markedly.

Since various data that is referred to for the generation of the first correction data is not stored or processed by the second input image correction circuit, the required capacity of a storing unit such as memory included in the second input image correction circuit does not increase. In addition, the configuration of various circuits included in the second input image correction circuit is not complicated.

The second input image correction circuit corrects the corrected input image data on the basis of the plurality of second reference correction data corresponding respectively to the plurality of specific levels among levels that the input image data can take and set respectively for the plurality of reference coordinates for reducing the color non-uniformity of the projection image. The level of the input image data is a signal level that defines the luminance level of the image displayed in the display area, for example, a voltage applied to electro-optical materials such as liquid crystals. By setting the second reference correction data corresponding respectively to the plurality of specific levels among the levels of the input image data, the data amount of the second reference correction data that should be prepared in advance in the second input image correction circuit can be reduced.

The plurality of reference coordinates mean, in a case where each of the plurality of pixels constituting the display area is defined as a coordinates, a plurality of the coordinates, that is, specific pixels selected from the plurality of pixels. The plurality of reference coordinates that are spaced equally are selected from the plurality of coordinates.

The second input image correction circuit corrects the corrected input image data on the basis of the plurality of second reference correction data set respectively for the plurality of reference coordinates in addition to the above-described plurality of specific levels for reducing the color non-uniformity of the projection image. Accordingly, the data amount of the second reference correction data can be reduced, when compared with a case where the second reference correction data for specific levels of all the coordinates are prepared. The second input image correction circuit can reduce the data amount of the second reference correction data that are prepared by the second input image correction circuit integrally, that is, for both sides of the levels and coordinates of the input image.

As a result, the electro-optical device according to the first exemplary embodiment can reduce the color non-uniformity of the projection image at a high speed each time the size of the projection image changes without complicating the configuration of various circuits included in the electro-optical device, and thereby a high quality projection image can be projected.

The display device may be a projection-type display device having a zoom function for changing the size of the projection image, and the first input image correction circuit may include a zoom amount detecting circuit detecting the zoom amount of the zoom function of the display device, a first reference correction data storage circuit storing a plurality of the first reference correction data, that are set so as to correspond to a plurality of specific zoom amounts among the zoom amounts, for each zoom amount, a first correction data generating circuit generating the first correction data by interpolating the plurality of the first reference correction data in accordance with the detected zoom amount, and a first correction data adding circuit adding the first correction data to the input image data.

In this case, the first reference correction data storage circuit, for example, includes a plurality of lookup tables in which the plurality of first reference correction data are stored respectively in correspondence with the plurality of specific zoom amounts. The plurality of lookup tables store the first reference correction data set for one zoom amount of a lens configured in a wide (enlargement) side for displaying the projection image on an enlarged scale and the other zoom amount of a lens configured in a tele (telescopic) side for displaying the projection image on a reduced scale such that the color non-uniformity cannot be noticed by human eyes in a status with the projection image displayed on the screen in advance.

The first correction data generating circuit generates the first correction data that is optimized for the zoom amount, that is, the first correction data capable of correcting the input image data so as not to make the color non-uniformity of the projection image be noticeable for the zoom amount by interpolating the first reference correction data, for example, for one zoom amount of a lens configured in the wide (enlargement) side and the other zoom amount of a lens configured in the tele (telescopic) side. The first correction data is calculated each time when the size of the projection image changes, that is, when the zoom amount of the lens changes. Accordingly, the first input image correction unit does not need to store the first correction data that is needed each time the zoom amount of the lens changes. In addition, the interpolation process of the first reference correction data for one zoom amount of the lens configured in the wide (enlargement) side and the other zoom amount of the lens configured in the tele (telescopic) side can be performed at a speed higher than that of the process performed by the second input image correction circuit.

The first correction data adding circuit adds the first correction data to the input image data. Accordingly, the color non-uniformity occurring in the projection image due to the zoom amount of the lens can be reduced.

In the case, the first reference correction data storage circuit may store the first reference correction data for each of the specific levels of the input image data or for each set of reference coordinates, and the first correction data generating circuit may interpolate the plurality of first reference correction data among the specific levels that are different from each other or the sets of reference coordinates that are different from each other.

In this case, the color non-uniformity of the image displayed in the display area can be reduced before the second input image correction circuit corrects the input image data. Here the first correction data generated by interpolating the plurality of first reference correction data among the specific levels that are different from each other or the reference coordinates that are different from each other is less precise than the second correction data. To be more specific, since the first correction data is generated by the first input image correction circuit such that the color non-uniformity occurring in accordance with the zoom amount is not noticeable, the interpolation is performed on the basis of reference values of which number is less than that of the second correction data that is generated on the basis of both the plurality of specific levels and the plurality of reference coordinates levels, and accordingly, the precision of correction for the input image data may be low.

The second correction circuit may include a second reference correction data storage circuit storing the second reference correction data for each set of the plurality of reference coordinates, a second correction data generating circuit generating second correction data corresponding to each level by performing an interpolation process for the levels of the second reference correction data for each set of reference coordinates, a second correction data storage circuit storing second correction data in correspondence with a set of reference coordinates and a level, a second correction data selecting circuit selecting a second correction data among the second correction data stored in the second correction data storage circuit that corresponds to a plurality of sets reference coordinates positioned in proximity to a set of coordinates determined on the basis of address information in the display area and the level, a third correction data generating circuit generating third correction data corresponding to the input image data by performing an interpolation process for the coordinates of the second correction data selected by the second correction data selecting circuit, and a third correction data adding circuit adding the third correction data to the corrected input image data.

In this case, the second correction circuit, for example, is a memory including a plurality of lookup tables storing the second reference correction data corresponding respectively to the plurality of reference coordinates for different levels. The second correction data performs an interpolation process for the second reference correction data in a level direction so as to generate the second correction data corresponding to each level for each of the reference coordinates, In other words, the second correction data corresponding to levels that are not selected as the specific levels are generated by the interpolation process,

In addition, the second correction data selecting circuit, for example, selects a second correction data piece among the second correction data that corresponds to the plurality of reference coordinates and the level. The reference coordinates, for example, are positioned in proximity of coordinates determined by the address information in accordance with a clock signal.

In addition, the third correction data generating circuit generates the third correction data corresponding to the input image data by performing an interpolation process in the coordinate direction for the second correction data piece selected by the second correction data selecting circuit. Accordingly, the third correction data for correcting the luminance non-uniformity is generated for coordinates for which the correction data is not set in advance. The third data adding circuit adds the third correction data to the corrected input image data for which a correction process for reducing the color non-uniformity on the basis of the size of the projection image has been performed by the first input image correction circuit.

Accordingly, in this case, the input image data is corrected for the size of the projection image, the level of the input image data, and the coordinates in the display area, whereby the color non-uniformity of the projection image is reduced.

According to a second exemplary embodiment, there is provided an electro-optical device in which an image to be projected on a projection surface as a projection image having a size than can be changed is displayed in a display area on the basis of input image data. The electro-optical device includes a first correction circuit generating correction data for reducing color non-uniformity of the projection image on the basis of a plurality of reference correction data that correspond to a plurality of specific levels among levels that the input image data can have and set for a plurality of sets of reference coordinates in the display area and a second correction circuit correcting the correction data on the basis of a correction coefficient that is set on the basis of a change in the size of the projection image.

The electro-optical device according to the second exemplary embodiment, for example, is a liquid crystal display used as a light valve of a projection-type display device such as a projector capable of displaying a projection image projected on a projection surface such as a screen on an enlarged or reduced scale by using magnifying and telescopic function of an optical system such as a lens, like the above-described electro-optical device.

The first correction circuit generates correction data on the basis of a plurality of reference correction data that is set for a plurality of specific levels and a plurality of reference coordinates. The specific levels correspond to luminance levels in the display area, as in the above-described electro-optical device. The specific levels are set for all the coordinates in the display area, to be more specific, for a plurality of reference coordinates set for all the pixels in advance. Accordingly, the first correction circuit, for example, can generate correction data for a predetermined levels and coordinates by interpolating the plurality of reference correction data for the level and reference coordinates of the input image data.

The second correction circuit corrects the correction data on the basis of a correction coefficient that is set on the basis of the change in size of the projection image. The correction coefficient, for example, is a numeric value that is stored in a lookup table in advance or generated by an calculation process so as to reduce the color non-uniformity occurring due to the size of the projection image, to be more specific, the zoom amount of a lens for displaying the projection image on an enlarged or reduce scale. The correction coefficient, for example, is applied to a case where the occurring tendency of the color non-uniformity of the projection image is uniform, to be more specific, to a case where the distribution of the color non-uniformity in the projection image, that is, the tendency is fixed and the luminance changes depending on the size of the projection image. Accordingly, for example, by only multiplying the third correction data by the correction coefficient, the correction data is corrected such that the correction data can be used for reducing the color non-uniformity. In addition, since the third correction data can be corrected on the basis of the correction coefficient that is selected in accordance with the size of the projection image or is generated, the color non-uniformity of the projection can be reduced at a high speed, for example, on the basis of the zoom amount of the lens.

In the electro-optical device according to the second exemplary embodiment, the first correction circuit may include a reference correction data storage circuit storing the reference correction data for each set of the plurality of reference coordinates, a first correction data generating circuit generating first correction data corresponding to levels of the reference correction data by performing an interpolation process for the levels of the reference correction data for each set of reference coordinates, a first correction data storage circuit storing the first correction data in correspondence with a set of reference coordinates and a level, a selection circuit selecting a first correction data piece among the first correction data stored in the first correction data storage circuit which corresponds to a plurality of reference coordinates positioned near a set of coordinates determined on the basis of address information in the display area and the level, and a correction data generating circuit generating the correction data by performing an interpolation process for the sets of coordinates of the first correction data piece selected by the selection circuit.

In this case, the reference correction data storage circuit, for example, is a memory including a plurality of lookup tables storing the reference correction data corresponding to the plurality of reference coordinates for different levels. The first correction data generating circuit generates the first correction data corresponding to each level for each of the reference coordinates by performing an interpolation process for the reference correction data in a level direction. In other words, the first correction data corresponding to the levels that are not selected as the specific levels is generated by an interpolation process.

The first correction data selecting circuit selects first correction data pieces from the first correction data corresponding to the nlurality of reference coordinates and levels. The reference coordinates, for example, are positioned in proximity of a coordinates specified by address information generated on the basis of a clock signal.

The correction data generating circuit generates the correction data corresponding to the input image data by performing an interpolation process for the first correction data piece, selected by the selection circuit, in the coordinate direction. Accordingly, the correction data for correction of the luminance non-uniformity for coordinates for which the correction data is not set is generated.

Accordingly, in this case, the input image data is corrected for the size of the projection image, the level of the input image data, and the coordinates in the display area, whereby the color non-uniformity of the projection image is reduced.

According to a third exemplary embodiment, there is provided an image processing circuit for reducing color non-uniformity of a projection image which occurs on the basis of a change in the size of the projection image at a time when an image displayed in a display area of an electro-optical device is projected on a projection surface as the projection image. The image processing circuit includes a first input image correction circuit generating first correction data, which is used for reducing the color non-uniformity of the projection image occurring due to the size change, on the basis of the size of the projection image and correcting the input image data using the generated first correction data and a second input image correction circuit correcting the corrected input image data on the basis of a plurality of second reference correction data that correspond to a plurality of specific levels among levels that the input image data can have and correspondingly set for a plurality of sets of reference coordinates in the display area for reducing the color non-uniformity.

The image processing circuit according to the third exemplary embodiment, as the above-described electro-optical device can reduce the color non-uniformity of the projection image at a high speed on the basis of the size of the projection image.

According to a fourth exemplary embodiment, there is provided an image processing circuit for reducing color non-uniformity of a projection image which occurs on the basis of a change in the size of the projection image at a time when an image displayed in a display area of an electro-optical device is projected on a projection surface as the projection image. The image processing circuit includes a first correction circuit generating correction data for reducing color non-uniformity of the projection image on the basis of a plurality of reference correction data that correspond to a plurality of specific levels among levels that the input image data can have and set respectively for a plurality of sets of reference coordinates in the display area and a second correction circuit correcting the correction data on the basis of a correction coefficient that is set in accordance with the size change.

The image processing circuit according to the fourth exemplary embodiment, as the above-described electro-optical device, can reduce the color non-uniformity of the projection image at a high speed.

According to a fifth exemplary embodiment, there is provided an image processing method of reducing color non-uniformity of a projection image which occurs on the basis of a change in the size of the projection image at a time when an image displayed in a display area of an electro-optical device is projected on a projection surface as the projection image. The image processing method includes generating first correction data, which is used for reducing the color non-uniformity of the projection image occurring due to the size change, on the basis of the size of the projection image and correcting the input image data using the generated first correction data and correcting the corrected input image data on the basis of a plurality of second reference correction data that correspond to a plurality of specific levels among levels that the input image data can have and set respectively for a plurality of sets of reference coordinates in the display area for reducing the color non-uniformity.

By using the image processing method according to the fifth exemplary embodiment, as the above-described image processing circuit, the color non-uniformity of the projection image can be reduced at a high speed.

According to a sixth exemplary embodiment, there is provided an image processing method for reducing color non-uniformity of a projection image which occurs on the basis of a change in the size of the projection image at a time when an image displayed in a display area of an electro-optical device is projected on a projection surface as the projection image. The image processing method includes generating correction data for reducing color non-uniformity of the projection image on the basis of a plurality of reference correction data that corresponds respectively to a plurality of specific levels among levels that the input image data can have and set respectively for a plurality of sets of reference coordinates in the display area and correcting the correction data on the basis of a correction co-efficient that is set in accordance with the size change.

By using the image processing method according to the fifth exemplary embodiment, as the above-described image processing circuit, the color non-uniformity of the projection image can be reduced at a high speed.

According to a seventh exemplary embodiment, there is provided an electronic device including the above-described electro-optical device.

The electronic device according to the seventh exemplary embodiment includes the above-described electro-optical device, and thus, can provide a projection-type display device such as a projector capable of displaying high-quality images with reduced color non-uniformity.

According to an eighth exemplary embodiment, there is provided a projection-type display device including the above-described electro-optical device.

The projection-type display device according to the eighth exemplary embodiment includes the above-described electro-optical device, and thus, can provide a projection-type display device such as a projector capable of displaying high-quality images with reduced color non-uniformity.

The above-described features and other advantages will become more apparent in the following detail exemplary embodiments.

### BRIEF DESCRIPTION OF THE DRAWINGS

Exemplary embodiments of the invention will be described with reference to the accompanying drawings, wherein like numbers reference like elements.

FIG. 1 is a block diagram showing the electrical configuration of a projector according to a first embodiment of the invention.

FIG. 2 is a plan view of the projector according to the first embodiment of the invention.

FIG. 3 is a block diagram showing the configuration of a first color non-uniformity correction circuit included in the projector according to the first embodiment of the invention.

FIG. 4 is a diagram showing a relationship between first correction data generated by the first color non-uniformity correction circuit and the zoom amount of a projection lens.

FIG. 5 is a block diagram showing the configuration of second color non-uniformity correction circuit included in the projector according to the first embodiment of the invention.

FIG. 6 is a diagram for describing reference coordinates according to the first embodiment of the invention.

FIG. 7 is a diagram showing a relationship between the display characteristics of a liquid crystal display panel and three voltage levels corresponding to reference correction data.

FIG. 8 is a diagram showing a lookup table stored in a ROM included in the second color non-uniformity correction circuit.

FIG. 9 is a flowchart showing an image processing method according to the first embodiment of the invention.

FIG. 10 is a diagram showing a system used for setting the reference correction data Dref.

FIG. 11 is a diagram showing the contents stored in a correction table included in the first color non-uniformity correction circuit.

FIG. 12 is a block diagram showing the electrical configuration of a projector 140 according to a second embodiment of the invention.

FIG. 13 is a block diagram showing the configuration of a color non-uniformity correction circuit 402 included in the projector according to the second embodiment of the invention.

FIG. 14 is a block diagram showing the configuration of a correction coefficient generating unit included in the projector according to the second embodiment of the invention.

FIG. 15 is a flowchart showing an image processing method according to the second embodiment of the invention.

### DESCRIPTION OF EXEMPLARY EMBODIMENTS

### First Embodiment

At first, an electro-optical device, an image processing circuit, an image processing method, and an electronic device including the electro-optical device according to embodiments of the present invention will be described. A three panel-type projector (projection-type projector) using a liquid crystal display panel that is a type of electro-optical device as a light valve is exemplified in the embodiments. The projector is an example of the electronic device according to an embodiment of the invention. The projector can project a composed image of projection images that project through three light valves corresponding to R (red light), G (green light), and B (blue light) on a projection surface such as a screen on an enlarged scale.

### 1-1: Electrical Configuration of Projector

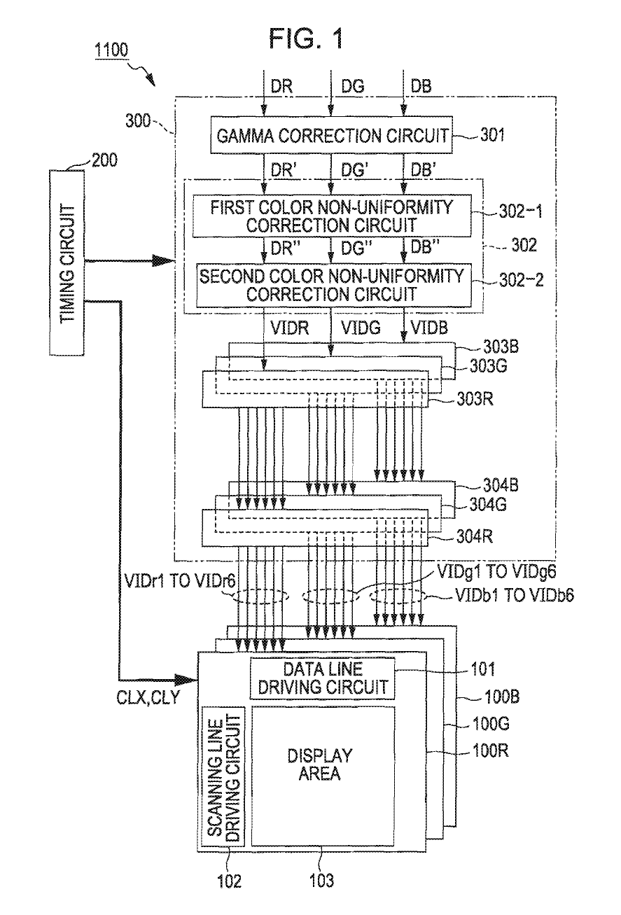

At first, an electrical configuration of a projector 1100 according to an embodiment of the invention will be described with reference to FIG. 1. FIG. 1 is a block diagram showing the electrical configuration of the projector 1100 according to an embodiment of the invention. The projector 1100 includes three liquid crystal display panels 100R, 100G, and 100B, a timing circuit 200, and an image signal processing circuit 300.

The liquid crystal display panels 100R, 100G, and 100B respectively correspond to primary color light of R (red), G (green), and B (blue) and display an image using the colors. Each of the liquid crystal display panels 100R, 100G, and 100B is formed by sandwiching liquid crystals between a component substrate and an opposite substrate, and a data line driving circuit 101 and a scanning line driving circuit 102 are provided on peripheral edges of a display area 103 of the component substrate.

A plurality of data lines and a plurality of scanning lines are formed so as to intersect each other in the display area 103. TFTs serving as switching elements are provided in correspondence with the intersections of the data lines and the scanning lines. A gate electrode, a source electrode, and a drain electrode of each TFT are electrically connected respectively to a scanning line, a data line, and a pixel electrode. One pixel is formed by a TFT, a pixel electrode, and an opposite electrode provided on the opposite substrate. The position of a pixel in the display area 103 is given by a set of coordinates.

The data line driving circuit 110 and the scanning line driving circuit 102 drive the pixels by supplying various signals respectively to the plurality of data lines and the plurality of scanning lines which are formed in the display area 103. In the embodiment, the number of dots of the display area 103 is assumed to correspond to XGA (1024 horizontal dots×768 vertical dots) for the convenience of description.

The timing circuit 200 supplies various timing signals to the data line driving circuit 101, the scanning line driving circuit 102, and the image signal processing circuit 300 when the projector 100 is operated. The image signal processing circuit 300 includes a gamma correction circuit 301, a color non-uniformity correction circuit 302, S/P conversion circuits 303R, 303G, and 303B, and inverting amplifier circuits 304R, 304G, and 304B.

The gamma correction circuit 301 performs gamma correction respectively for input image data DR, DG, and DB, which are digital signals, in accordance with display characteristics of the liquid crystal panels 100R, 100G, and 100B and outputs resultant image data DR′, DG′, and DB′.

The color non-uniformity correction circuit 302 includes a first color non-uniformity correction circuit 302-1 which is an example of a first input image correction circuit and a second color non-uniformity correction circuit 302-2 which is an example of a second input image correction circuit.

The color non-uniformity correction circuit 302 performs a color non-uniformity correction process to be described later for the image data DR′, DG′, and DB′ which are examples of corrected input image data and performs a D/A conversion process on the corrected data for outputting resultant signals as image signals VIDR, VIDG, and VIDB. The configurations and operations of the first color non-uniformity correction circuit 302-1 and the second color non-uniformity correction circuit 302-2 will be described later in detail.

The S/P conversion circuit 303R corresponding to R distributes the image signal VIDR into six series and expands (serial-parallel conversion) the image signal by six times in the time axis for outputting. The reason for the conversion into image signals of six series is to acquire the sampling time and charge/discharge time of a data signal of the liquid crystal display panel sufficiently by lengthening the application time of the image signal supplied to a TFT in a sampling circuit (built in the data line driving circuit 101) of the liquid display panel.

The inverting amplifier circuit 304R corresponding to R inverts the polarity of the image signals and amplifies the inverted image signals to supply the resultant signals to the liquid crystal display panel 100R as image signals VIDr1 to VIDr6.

In addition, the image signal VIDG corresponding to G output by the color non-uniformity correction circuit 302 is similarly converted into six series by the S/P conversion circuit 303G and then amplified with the polarity inverted by the inverting amplifier circuit 304G for being supplied as image signals VIDg1 to VIDg6 to the display panel 100G. Similarly, the image signal VIDB corresponding to B is converted into six series by the S/P conversion circuit 303B and then amplified with the polarity inverted by the inverting amplifier circuit 304B so as to be supplied as image signals VIDb1 to VIDb6 to the liquid crystal display panel 100B.

The polarity inversion in the inverting amplifier circuits 304R, 304G, and 304B involves inverting the voltage level of the image signal alternatingly with respect to the amplitude center voltage of the image signal as a reference. The period of polarity inversion may be arbitrarily set as polarity inversion in units of scanning lines, polarity inversion in units of data signal lines, or polarity inversion in units of one frame on the basis of the application mode of the data signal.

### 1-2: Detailed Configuration of Projector

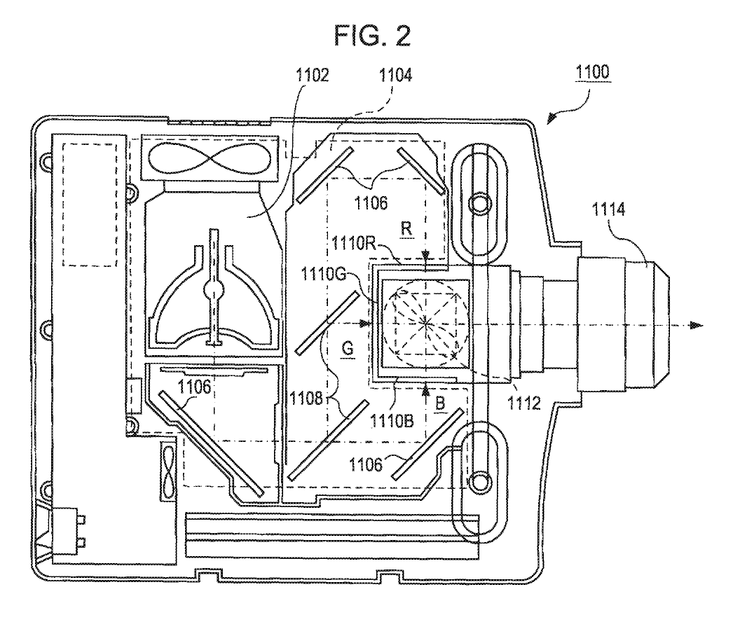

Next, the detailed configuration of the projector 1100 will be described with reference to FIG. 2. FIG. 2 is a plan view of the projector 1100. As shown in FIG. 2, inside the projector 1100, a lamp unit 1101 including a white light source such as a halogen lamp is provided. The projection light emitted from the lamp unit 1102 is divided into light of primary colors of R, G, and B by four mirrors 1106 and two dichroic mirrors 1108 disposed inside a light guide 1104 and incident to the liquid crystal panels 100R, 100B, and 100G as light valves.

The image signals VIDr1 to VIDr6, VIDg1 to VIDg6, and VIDb1 to VIDb6 of R, G, and B that are processed by the image signal processing circuit 300 (omitted in FIG. 2) are supplied respectively to the liquid crystal panels 100R, 100B, and 100G. By the supply of the image signals, the liquid crystal panels 100R, 100B, and 100G serve as light modulators that generate respectively primary color images of R, G, and B. The light modulated by the liquid crystal panels is incident to the dichroic prism 1112 from three directions. In the dichroic prism 1112, the light of R and B is reflected by 90 degrees and the light of G propagates straight. Accordingly, a composed image of the primary color light is projected on a screen or the like through a projection lens 1114. The projector 1110 projects the composed image as wide (enlargement) projection or tele (reduction) projection on the basis of the zoom amount of the projection lens 1114 and has a zoom function for projecting the composed image that becomes a projection image on a projection surface such as a screen on an enlarged or reduced scale.

As for the zoom function, digital zoom performed by signal processing along with optical zoom performed by a zoom operation of the projection lens may be used.

### 1-3: Configuration of Image Processing Circuit

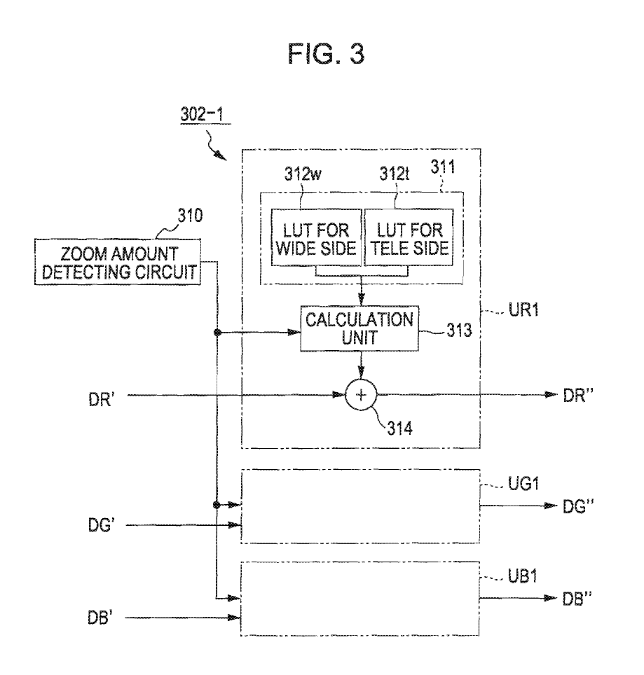

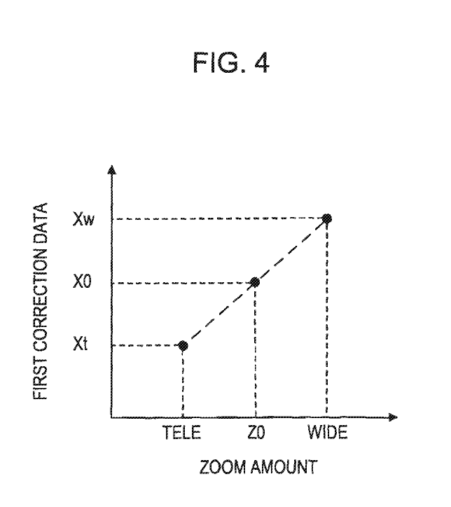

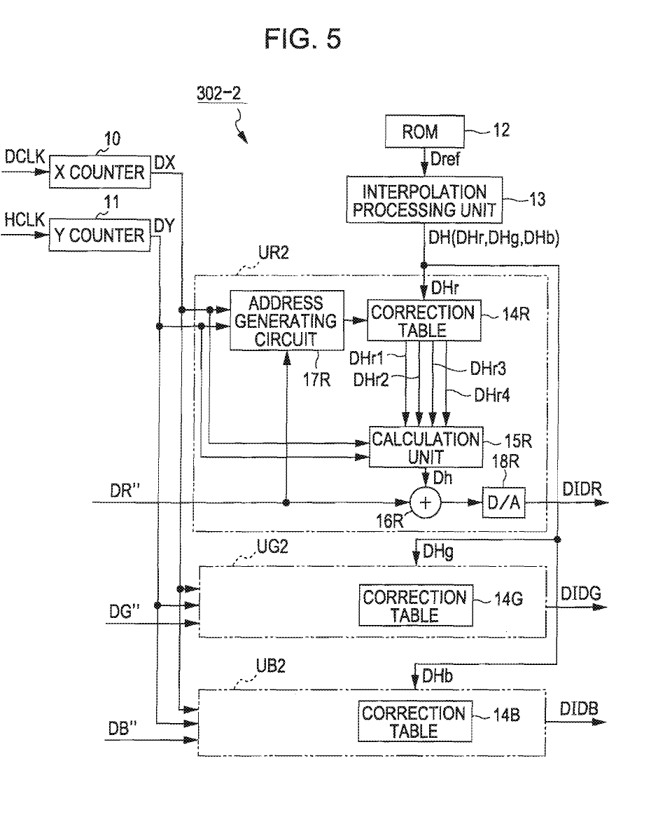

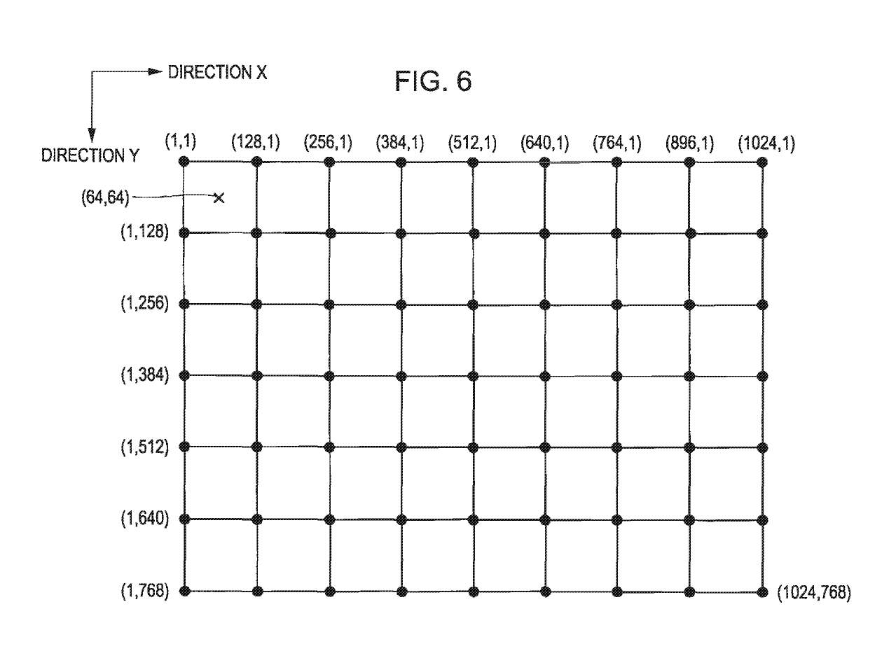

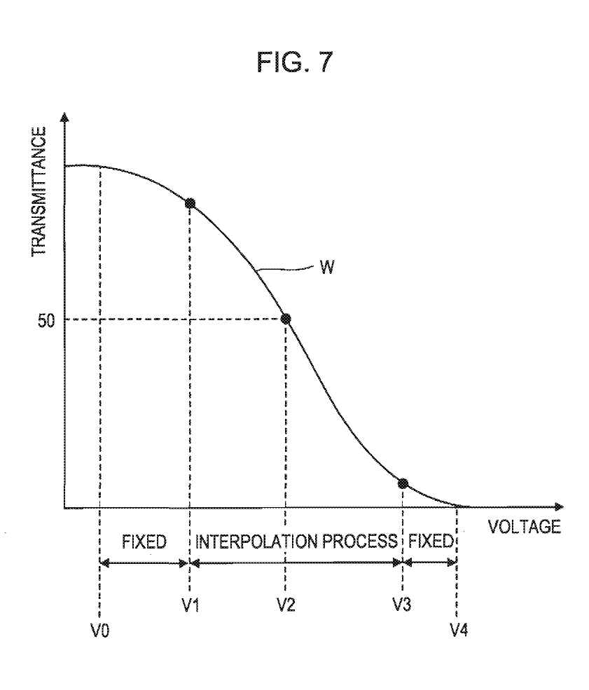

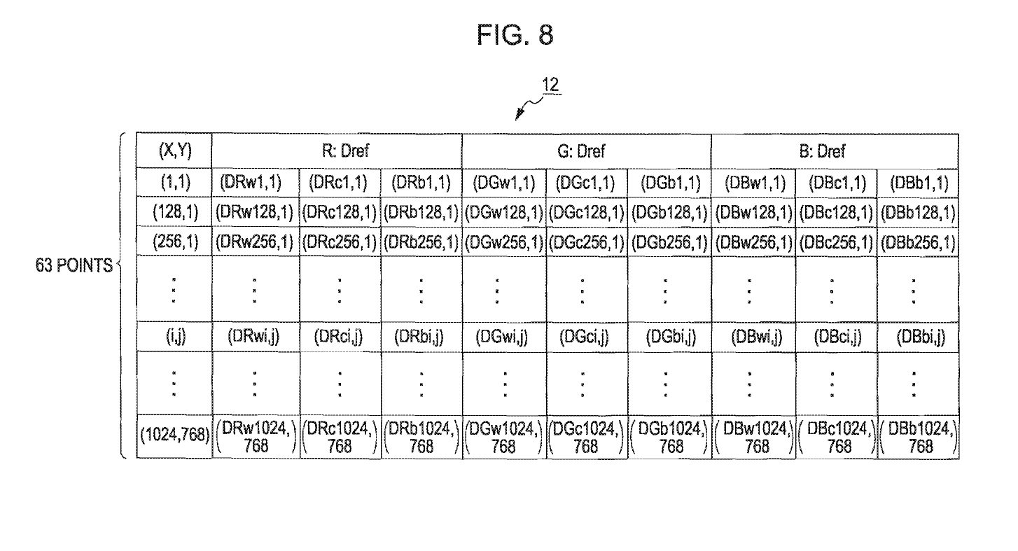

The configurations of the first and second color non-uniformity correction circuits 302-1 and 302-2 which are included in the color non-uniformity correction circuit 302 will be described with reference to FIGS. 3 to 8. The first and second color non-uniformity correction circuits 302-1 and 302-2 constitute an image processing circuit according to an embodiment of the invention. FIG. 3 is a block diagram showing the configuration of the first color non-uniformity correction circuit 302-1. FIG. 4 is a diagram showing a relationship between first correction data generated by the first color non-uniformity correction circuit 302-1 and the zoom amount of the projection lens 1114 shown in FIG. 2. FIG. 5 is a block diagram showing the configuration of the second color non-uniformity correction circuit 302-1. FIG. 6 is a diagram for describing sets of reference coordinates according to an embodiment of the invention. FIG. 7 is a diagram showing a relationship between the display characteristics of a liquid crystal display panel and three voltage levels corresponding to reference correction data. FIG. 8 is a diagram showing a lookup table stored in a ROM included in the second color non-uniformity correction circuit.

Hereinafter, a process performed for image data corresponding to R (red) and circuit units performing the process will be mainly described, however, the same process is performed for the image data corresponding to G (green) and B (blue) by using the same configuration as that for the image data corresponding to R.

In FIG. 3, the first color non-uniformity correction circuit 302-1 includes a zoom amount detecting circuit 310 and correction units UR1, UG1, and UB1. The correction unit UR1 includes a memory device 311 as an example of the first reference correction data storage circuit, a calculation unit 313 as an example of the first correction data generating circuit, and an adding unit 314 as an example of the first correction data adding circuit.

The zoom amount detecting circuit 310 detects the zoom amount of the projection lens 1114, to be more specific, the shift amount of the projection lens 1114 shifted in correspondence with the wide (enlargement) side and tele (reduction) side.

The memory device 311 includes a plurality of lookup tables including the first reference correction data set in correspondence with a plurality of specific zoom amounts among the zoom amounts that the projection lens 1114 can have. In this embodiment, as detailed examples of the plurality of lookup tables, a LUT 312W including the first reference correction data piece set in the wide side and a LUT 312T including the first reference correction data piece set in the tele side are included. The first reference data included in LUTs 312W and 312T are respectively correction values for input image data DR′ that are used for correcting the input image data DR′ such that the color non-uniformity does not occur in a projection image when the projection image is projected on a screen with the projection lens 1114 shifted to wide side and tele side in advance.

While the first reference correction data are set for the zoom amounts of the projection lens 1114, that is, specific values of the absolute values of shifted amount in cases where the projection lens 1114 is shifted respectively to the wide side and the tele side in this embodiment, the first reference correction data may be set for a plurality of specific zoom amount among the zoom amounts of the projection lens 1114 that are shifted amounts of the projection lens 1114 respectively to the wide side and the tele side from a reference zoom amount among the zoom amounts of the projection lens 1114 for which the color non-uniformity does not occur in the projection image without correction of the input image data DR′.

The calculation unit 313 acquires information on the zoom amount of the projection lens 1114 from the zoom amount detecting circuit 310. The calculation unit 313 reads out the data stored in LUTs 312W and 312T and calculates the first correction data on the basis of the zoom amount that has been acquired from the zoom amount detecting circuit 310 corresponding to the zoom amount.

To be more specific, as shown in FIG. 4, the calculation unit 313 calculates first correction data X0 in correspondence with the zoom amount Z0 by performing an interpolation process using the first correction data Xt set in the tele side and the first correction data Xw set in the wide side. In FIG. 4, zoom amounts denoted by tele and wide on the horizontal axis are examples of specific zoom amounts.

Again in FIG. 3, the adding unit 314 adds the first correction data X0 supplied from the calculation unit 313 to the input image data DR′ and supplies input image data DR″ to the second color non-uniformity correction circuit 302-2. Similarly, the input image data DG′ and DB′ corrected by the first color non-uniformity correction circuit 302-1 are output to the second color non-uniformity correction circuit 302-2. The first color non-uniformity correction circuit 302-1 can display a projection image in which the color non-uniformity occurs on the basis of the size of the projection image, that is, the zoom amount of the projection lens 1114 on a screen. In addition, since the correction data for reduction of the color non-uniformity that occurs on the basis of the size of the projection image is not required to be stored in a lookup table included in a second color non-uniformity correction circuit 302-2 to be described later, the memory capacity required for the second color non-uniformity correction circuit 302-2 does not increase. In addition, since the status of the color non-uniformity occurring due to the size of the projection irnage depends on the optical characteristics of an optical system including the wavelengths corresponding to each color and the projection lens 1114 that projects the light on the screen, the correction performed for the color non-uniformity occurring due to the size of the projection image has a low precision compared with correction for the color non-uniformity of an image displayed in the display area 103, whereby the correction for the color non-uniformity can be performed at a high speed.

In this embodiment, the memory device 311 nay store the first reference correction data for each luminance level of the input image data DR′ or each reference coordinate, and the calculation unit 313 may interpolate the plurality of first reference correction data for each of different specific levels included in the plurality of specific levels or for each set of different reference coordinates among the plurality of sets of reference coordinates. In this case, before the second color non-uniformity correction circuit 303-2 corrects the input image data DR″, the luminance non-uniformity of the image displayed in the display area 103 can be reduced. The precision of the first correction data that is generated by interpolating the first reference correction data for each of the different specific levels or each set of the different reference coordinates on the basis of the zoom amount of the projection lens 1114 is lower than that of the second correction data that is generated by the second color non-uniformity correction circuit 302-2. To be more specific, since the first correction data may be generated by the first color non-uniformity correction circuit 302-1 such that the color non-uniformity occurring due to the zoom amount of the projection lens 1114 is not detected, the interpolation is performed on the basis of reference values, the number of which is less than that for the second reference data that is generated on the basis of both the plurality of specific levels and the plurality of reference coordinate levels, and accordingly, the precision of the correction for the input image data DR′ may be low.

Next, the configuration of the second color non-uniformity circuit 302-2 will be described with reference to FIGS. 5 to 8. In FIG. 5, the second color non-uniformity circuit 302-2 includes an X counter 10, a Y counter 11, a ROM (Read Only Memory) 12, an interpolation processing unit 13, and correction units UR2, UG2, and UB2.

When the projector 1100 is operated, the X counter 10 counts a dot clock signal DCLK synchronized with a dot period and outputs X coordinate data Dx representing the X coordinate of the input image data. The Y counter 11 counts a horizontal clock signal HCLK synchronized with horizontal scanning and outputs Y coordinate data Dy representing the Y coordinate of the input image data. Accordingly, the set of coordinates of a dot (pixel) corresponding to the input image data can be detected by referring to the X coordinate data Dx and the Y coordinate data Dy.

The ROM 12 is a non-volatile memory. The ROM 12 outputs reference correction data Dref that is an example of the second reference correction data when power is supplied to the projector 1100. The reference correction data Dref corresponds to a plurality of sets of predetermined reference coordinates and specific levels of the colors of R, G, and B and becomes reference data for correcting the color non-uniformity using the second color non-uniformity correction circuit 302-2.

Here, the sets of reference coordinates in the embodiment will be described with reference to FIG. 6. In FIG. 6, the display area 103 includes 1024 horizontal dots×768 vertical dots. The display area 103 is divided into 8 horizontal×6 vertical blocks and the coordinates of 63 points (denoted as black circles in the figure) positioned at the apexes of the blocks are referred to as sets of reference coordinates in the embodiment.

Next, the specific levels for each color of R, G, and B will be described with reference to FIG. 7. FIG. 7 is a diagram showing points corresponding to voltage levels in correspondence with the reference correction data Dref in a display characteristic representing the relationship between an effective value of the voltage applied to a liquid crystal capacitor and transmittance (or luminance). In FIG. 7, a normal white mode in which the transmittance becomes the maximum (white display) in a case where the effective value of the voltage applied to the liquid crystal capacitor is zero is shown.

As shown in FIG. 7, in the display characteristic W, the transmittance decreases slowly as the effective value of the voltage applied to the liquid crystal capacitor increases from zero, the transmittance decreases rapidly as the effective value of the voltage exceeds a voltage level V1, and the transmittance decreases slowly as the effective value of the voltage exceeds a voltage level V3. Here, a voltage level V0 is the effective value of the voltage applied to the liquid crystal capacitor when the image data becomes the minimum level, and a voltage level V4 is an effective value of the voltage applied to the liquid crystal capacitor when the image data becomes the maximum level. In the display characteristic W, the reference correction data Dref in the embodiment is set for each of the voltage levels V1, V2, and V3 using a technique to be described later. The voltage levels V1 and V3 correspond to rapidly changing points in the display characteristic W, and the voltage level V2 corresponds to a point at which the transmittance corresponds to about 50%.

Here, the reasons the above-described three voltage levels are selected are as follows. First, since the change in the transmittance is small in the region having a voltage level smaller than the voltage level V1 or the region having a voltage level larger than the voltage level V3 although the levels (gradation or luminance) of the image data are markedly different, it can be generally assumed that using reference correction data Dref corresponding to the voltage level V1 or the voltage level V3 is sufficient. Second, when the reference correction data Dref corresponding to the voltage levels V0 and V4 instead of the voltage levels V1 and V3 is stored and correction data corresponding to each level in the range of the voltage levels V0 to V4 is calculated by interpolation, the display characteristic W changes rapidly at the voltage levels V1 and V3, and accordingly correction data cannot be calculated precisely over the whole region. Third, by using the voltage level V2 at which the transmittance is about 50%, the precision of the interpolation process can be improved.

When the above reasons are considered, since a liquid crystal display panel has a display characteristic depending on the composition of liquid crystals serving as electro-optical materials generally, the second color non-uniformity correction circuit 302-2 cannot perform precise correction, although all the levels that the image data can have are corrected using correction data corresponding to one level of the image data. To the contrary, it is ideal to store correction data in correspondence with all the levels of the image data, but in such a case, the required storage capacity in the ROM 12 increases, Thus, the second color non-uniformity correction circuit 302-2 stores reference correction data Dref in correspondence with three different levels, and correction data corresponding to levels other than the above-described three different levels is acquired by performing an interpolation process for the stored reference correction data Dref.

Next, the contents stored in the ROM 12 will be described with reference to FIG. 8. As shown in FIG. 8, the ROM 12 stores nine reference correction data pieces Dref for each of the reference coordinates of 63 points. To be more specific, the nine reference correction data pieces Dref corresponding to one set of reference coordinates are stored for each color of R, G, and B corresponding to a white reference level, a center reference level, and a black reference level, respectively. In FIG. 8, a first subscript “R”, “G”, or “B”following “D” that indicates data denotes to which color the reference correction data piece corresponds. Among the second subscripts, “w” denotes correspondence with the white reference level, “c” denotes correspondence with the center reference level, “c”, and “b” denotes correspondence with the black reference level, “b”. In addition, the third and fourth subscripts “i, j” denote a set of reference coordinates corresponding to the reference correction data piece. For example, “DRc256, 1” denotes that the reference correction data corresponds to R (red), the center reference level, and a set of reference coordinates (256,1). In the description below, when tie reference correction data piece is identified by each color of R, G, and B, the reference correction data pieces corresponding to R, G, and B are respectively denoted as Drefr, Drefg, and Drefb, and when the reference correction data piece is not identified by each color of R, G, and B, it is referred to as Dref only.

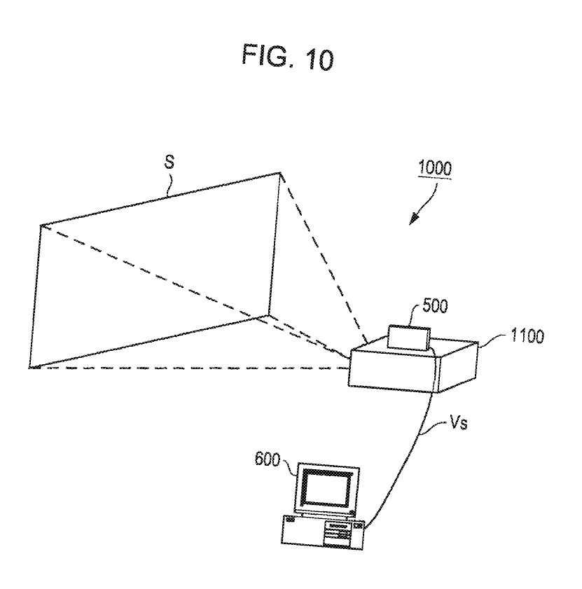

Next, the setting of the reference correction data will be described with reference to FIG. 10. FIG. 10 is a diagram showing a system used for setting the reference correction data Dref As shown in FIG. 10, the system 1000 includes a projector 1100 according to an embodiment of the invention, a CCD camera 500, a personal computer 600, and a screen S. The operation of the color non-uniformity correction circuit 302 is stopped. In the system 1100, the CCD camera 500 photographs an image projected on a screen S by the projector 1100 and converts the image into an image signal Vs for outputting. The personal computer 600 generates the reference correction data Dref in the following order by analyzing the image signal Vs.

At first, a signal generator which is not shown in the figure is connected to the system 1000 and supplies image data DR′ of R corresponding to the white reference level (image data DG′ and DB′ is fixed in correspondence with a voltage level V4 of the minimum transmittance). Accordingly, a projection image of one red color is displayed on the screen S. Next, the projection image is photographed by the CCD camera 500 and supplied to the personal computer 600 as the image signal Vs. Thereafter, the personal computer 600 divides the screen of one frame into six vertical blocks X eight horizontal blocks as shown in FIG. 6 using the image signal Vs, acquires the average luminance of each block, and calculates the luminance level at a position given by each set of reference coordinates on the basis of the average luminance level of each block. To be more specific, the personal computer 600 acquires a luminance level at a position given by a set of reference coordinates by calculating the average luminance of one, two, or four blocks that are adjacent to a position given by the set of reference coordinates.

Thereafter, the personal computer 600 compares the luminance level of the set of reference coordinates with a predetermined luminance level and calculates reference correction data Dref on the basis of the comparison result. In addition, the personal computer 600 performs the calculation operation similarly for the 63 sets of reference coordinates, the center reference level (voltage level V2), and the black reference level (voltage level V3) and calculates reference correction data Drefr in correspondence with R.

Subsequently, the image data DR′ and DB′ are fixed in correspondence with the voltage level V4 of the minimum transmittance, the image data DG′ of G is sequentially converted to correspond to the white reference level, the center reference level, and the black reference level, and the reference correction data Drefg corresponding to G are calculated by the personal computer 600. Similarly, the image data DR′ and DG′ are fixed so as to correspond to the voltage level V4 of the minimum transmittance, the image data DB′ of B is sequentially converted to correspond to the white reference level, the center reference level, and the black reference level, and the reference correction data Drefb corresponding to B are calculated by the personal computer 600. The calculated reference correction data Drefr, Drefg, and Drefb are stored in the ROM 12 of the projector 1100. Accordingly, the reference correction data is stored in the ROM 12.

Again in FIG. 5, the interpolation processing unit 13 calculates correction data DH for each set of reference coordinates and for each color of R, G, and B by interpolating the reference correction data Dref corresponding to the white reference level, the center reference level, and the black reference level. To be more specific, the interpolation processing unit 13 calculates the correction data DH corresponding to each level from the white reference level to the center reference level from the reference correction data Dref corresponding to the white reference level and the reference correction data corresponding to the center reference level. Likewise, the interpolation processing unit calculates the correction data DH corresponding to each level from the center reference level to the black reference level from the reference correction data Dref corresponding to the center reference level and the reference correction data corresponding to the black reference level. In the description below, the correction data DH corresponding to R, G, and B are denoted respectively as DHr, DHg, and DHb.

Next, in FIG. 5, the correction units UR2, UG2, and UB2 perform correction processes for the image data DR″, DG″, and DB″ corresponding to each color of R, G and B on the basis of the correction data generated by the interpolation processing unit 13. perform Digital-Analog conversion on the corrected data, and output the converted data as image signals VIDR, VIDG and VIDB. Here, since the correction units UR2, UG2, and UB2 have a common configuration in the embodiment, the correction unit UR2 will be described representatively. The correction unit UR2 includes a correction table 14R, a calculation unit 15R, an adding unit 16R, an address generating unit 17R, and a D/A converter 18R.

The correction table 14R stores the correction data DHr calculated by the interpolation processing unit 13 in a region having the set of reference coordinates as a row address and the level as a column address which is a coordinate axis and outputs correction data DHr1 to DHr4 of four points from a storage region designated by a read address.

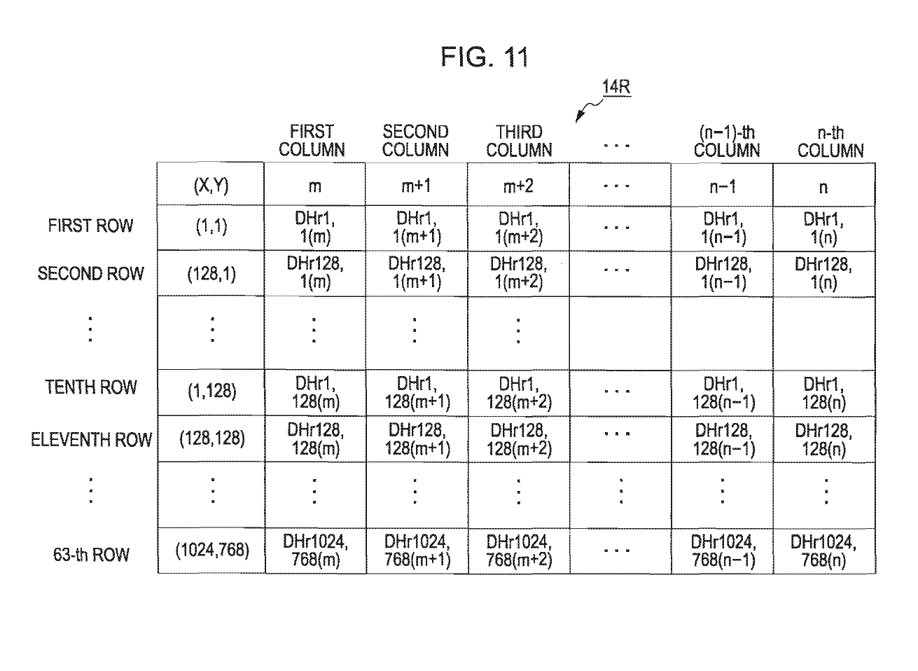

Here, the contents stored in the correction table 14R will be described with reference to FIG. 11. In FIG. 11, “m” denotes image data corresponding to the voltage level V1, and “n” denotes image data corresponding to the voltage level V3. As shown in FIG. 11, the correction table 14R stores the correction data DHr to be corresponded with each set of reference coordinates. The first and second subscripts “i, j” following DHr, that denotes the correction data, denote the reference coordinates, and the third subscript “(X)” denotes a level of corresponding image data. For example, “DHr1, 128(m+2)” denotes correction data corresponding to reference coordinates (1,128) and the level (m+2) of the image data.

In FIGS. 5 and 11, the address generating unit 17R sequentially generates four read-out addresses in the following order on the basis of the X coordinate data Dx, the Y coordinate data Dy, and the image data Dr″. First, the address generating unit 17R determines sets of reference coordinates of four points positioned in proximity of the set of coordinates given by the X coordinate data Dx and the Y coordinate data Dy. For example, when the coordinates specified by the X coordinate data Dx and the Y coordinate data Dy is (64, 64) (See FIG. 6), four sets of coordinates of (1, 1), (128, 1), (1, 128), and (128, 128) are determined as a set of reference coordinates. Accordingly, four row addresses indicating the first row, the second row, the tenth row, and the eleventh row are generated.

Second, the address generating unit 17R generates a row address corresponding to a level of the image data DR″. For example, when the level of the image data DR″ is “m+1”, the row address indicating the second row is generated. However, when the level of the image data DR″ is smaller than “m”, a row address indicating the first row is generated, and when the level of the image data DR″ is larger than “n”, a row address corresponding to “n” is generated.

Third, the address generating unit 17R generates four read-out addresses by combining four row addresses and one column address. Four correction data pieces DHr1 to DHr4 from the correction data DHr stored in the correction table 14R are selected by the address generating unit 14R. For example, when the image data DR′ is “m+1” and the coordinates given by the X coordinate Dx and the Y coordinate Dy is (64, 64), “DHr1, 1(m+1)”, “DHr128, 1(m+1)”, “DHr1, 128(m+1)”, and “DHr128, 128(m+1)” are read out from the correction table 14R as the correction data pieces DHr1 to DHr4 in FIG. 11.

Next, the calculation unit 15R acquires correction data Dh corresponding to the set of coordinates (set of coordinates corresponding to the image data DR″) specified by the X coordinate Dx and the Y coordinate Dy by performing an interpolation process using the correction data pieces DHr1 to DHr4 of the four read-out points, To be more specific, the calculation unit 15R acquires the correction data Dh by performing linear interpolation for the correction data pieces DHr1 to DHr4 of four points along each distance from the coordinates given by the X coordinate Dx and the Y coordinate Dy to the coordinates corresponding to the correction data pieces DHr1 to DHr4.

The adding unit 16R generates image data to which the correction process has been completed by adding the image data DR″ and the correction data Dh. The image data to which the correction process has been completed is output as an analog image signal VIDR through the D/A converter 18R. In this embodiment, a case where the image data DR″ of R (red) is corrected is described in detail, but the same color non-uniformity correction process is performed for the image data DR″ of G (green) and the image data DR″ of B (blue) to be output as analog signals VIDG and VIDB.

### 1-4: Image Processing Method

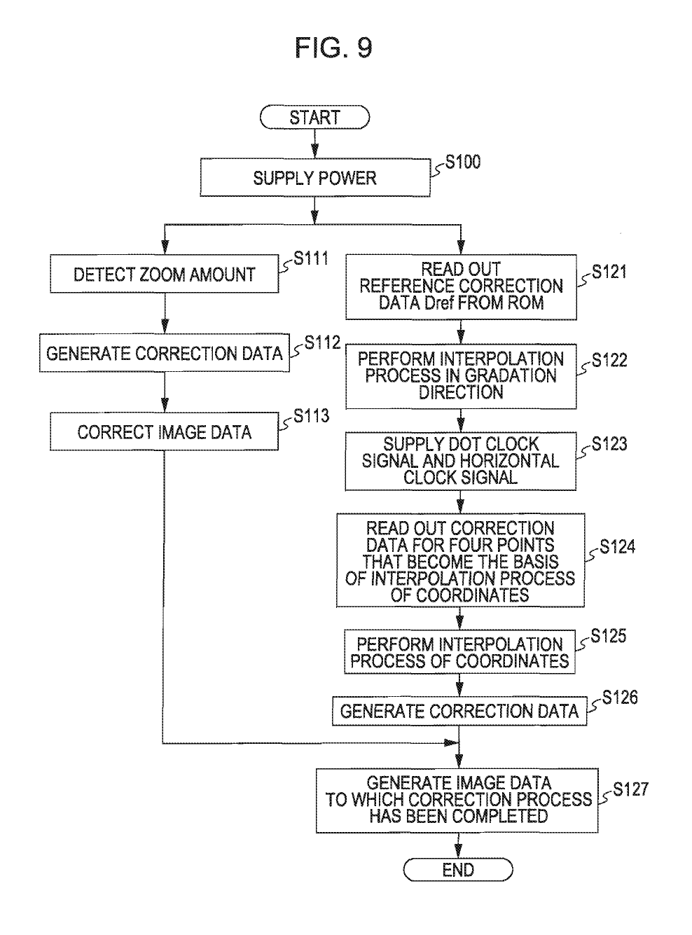

Next, an image processing method according to an embodiment of the invention will be described with reference to FIG. 9. FIG. 9 is a flowchart showing an image processing method according to an embodiment of the invention. The processes in the first and second color non-uniformity correction circuits 302-1 and 302-2 respectively form examples of the image processing method according to an embodiment of the invention. Here, an operation for the color non-uniformity correction corresponding to R will be described, but the operation for the color non-uniformity correction corresponding to B or G is the same.

At first, the process performed in the first color non-uniformity correction circuit 302-1 will be described. When the power is supplied to the projector 1100 (step S100), the zoom amount detecting circuit 310 detects the zoom amount of the projection lens 1114 in a status that the projector 1100 can project a projection image on the screen (S111). The calculation unit 313 reads out the first reference correction data from the memory device 311 and generates correction data on the basis of the zoom amount read by the zoom amount detecting circuit 310(S112). An adder 314 corrects the input image data DR′ by adding the generated correction data to the input image data DR′ and outputs the input image data DR″ for which the color non-uniformity due to the zoom amount can be reduced to the second color non-uniformity correction circuit 302-2 in the latter stage.

Next, the process performed in the second color non-uniformity correction circuit 302-2 will be described. When the power is supplied to the projector 1100 (step S100), the reference correction data Dref (Drefr, Drefg, and Drefb) corresponding to each set of reference coordinates is read from the ROM 12 in a status that the projector 1100 can project a projection image on the screen (step S121). Next, the interpolation processing unit 13 generates the correction data pieces DHr, DHg, and DHb by performing an interpolation process in a gradation (level) direction on the basis of the reference correction data Dref (step S122). In other words, since each of the reference correction data pieces Drefr, Drefg, and Drefr correspond only to three voltage levels V1, V2, and V3 in the sets of reference coordinates including 63 points, the correction data pieces DHr, DHg, and DHb corresponding to each level from the voltage level V1 to the voltage level V3 are generated respectively by interpolation processes.

Next, when the correction data pieces DHr, DHg, and DHb are stored respectively in correction tables of the correction units UR2, UG2, and UB2, a dot clock signal DCLK and a horizontal clock signal HCLK are respectively supplied to the X counter 10 and the Y counter 11 (step S123), and the image data DR″, DG″, and DB″ is supplied in synchronization with the clock signals. Here, it can be determined that to which dot (pixel) in the display area 103 the image data DR″, DG″, and DB″ corresponds in a specific timing by the X coordinate data Dx output from the X counter 10 and the Y coordinate data Dy output from the Y counter 11.

Thereafter, four correction data pieces DHr1 to DHr4 that become the base of the interpolation process for the coordinates are read out from the correction table 14R on the basis of the X coordinate data Dx, the Y coordinate data Dy, and the level of the image data DR″ (step S124). This operation also applies for other colors. Thereafter, the correction data Dh is generated (step S126) by interpolating the correction data pieces DHr1 to DHr4 on the basis of the X coordinate data Dx and the Y coordinate data Dy using the calculation unit 15R (step S125). The correction data Dh is added to the image data DR″ by the adding unit 16R (step S127), and the resultant data is converted by the D/A converter 15R into analog data to be output as the image signal VIDR of R (red). The same process is performed for G (green) and B (blue) and then, the resultant data is output as image signals VIDG and VIDB.

By using the above-described image processing method according to an embodiment of the invention, the input image data can be corrected at a high speed, whereby the color non-uniformity occurring due to the zoom amount of the projection lens 1114 can be reduced. In addition, the correction data Dh is generated by generating the Correction data DH corresponding to each level of the image data for each set of reference coordinates from the reference correction data Dref corresponding to each set of coordinates and three voltage levels V1, V2, and V3 and performing an interpolation process for the correction data pieces DHr1 to DHr4 of four points on the basis of the X coordinate data Dx and the Y coordinate data Dy. Accordingly, since a precise correction is performed on the basis of each level of the image data DR″, DG″, and DB″, the color non-uniformity or the luminance non-uniformity can be markedly reduced over all the gradations.

Since the correction data Dh is generated for each of the image data pieces DR″, DG″, DB″, it is possible to maintain white balance by supplementing with G and B in a case where the correction amount of R is insufficient. For example, when the number of bits of the image data DR″, DG″ and DB″ is ten and the number of bits of the correction data Dh is limited to four, there may be a case where the color non-uniformity cannot be completely corrected by a correction process for each color, but the color non-uniformity can be corrected by correcting using balances with other colors.

In the embodiment, since the interpolation process corresponding to the coordinates is performed after the interpolation process corresponding to the level of the gradation or the like, that is, the interpolation processes of two stages are performed, the required memory capacity of the ROM 12 and the correction table 14R can be reduced markedly. In addition, since the X counter 10, the Y counter 11, the ROM 12, and the interpolation processing unit 13 also serves as correction units UR2, UG2, and UB2, the configuration can be simple to that amount, whereby it becomes possible to reduce the costs.

### Second Embodiment

### 2-1: Electrical Configuration of Projector

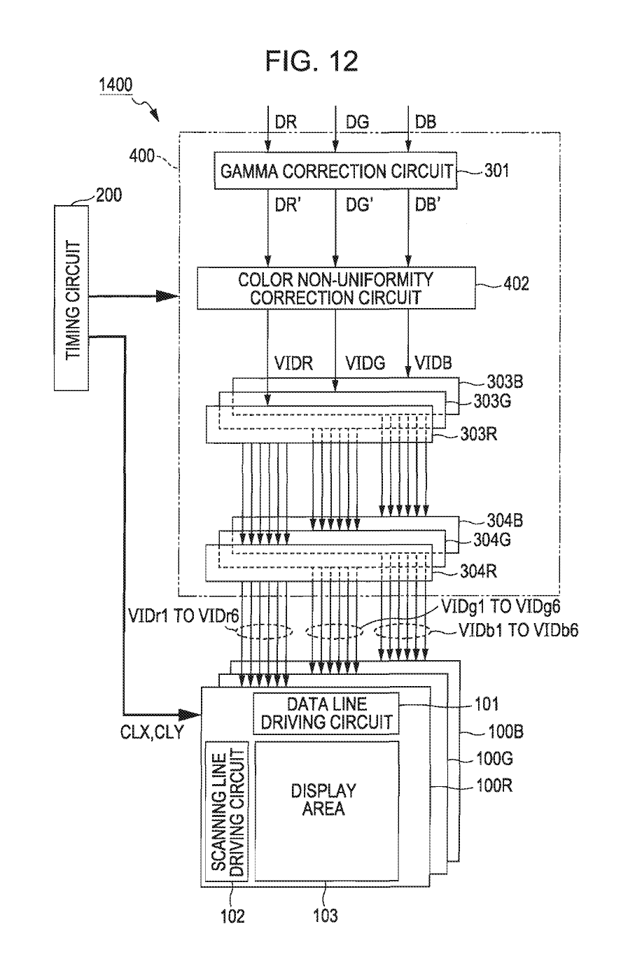

Next, an electro-optical device, an image processing circuit, and an image processing method according to other embodiments of the invention will be described with reference to FIGS. 12 to 15. Hereinafter, the same reference codes are attached to parts that are common with the electro-optical device according to the first embodiment of the invention, and detailed description thereof is omitted.

The electrical configuration of a projector 1400 according to another embodiment of the invention will be described with reference to FIG. 12. FIG. 12 is a block diagram showing the electrical configuration of the projector 1400 according to another embodiment of the invention. The projector 1400 includes three liquid crystal display panels 100R, 100C, and 100B, a timing circuit 200, and an image signal processing circuit 400, like the projector 1100.

The image signal processing circuit 400 includes a gamma correction circuit 301 and a color non-uniformity correction circuit 402 and an S/P conversion circuit 303 and an inverting amplifier circuit 304 which correspond to each color of red (R), green (G) and blue (B).

The color non-uniformity correction circuit 402 performs a color non-uniformity correction process, to be described later, for the input image data DR′, DG′, and DB′ and performs a D/A conversion process on the corrected input image data for outputting resultant signals as image signals VIDR, VIDC, and VIDB. The gamma correction circuit 301, the S/P conversion circuit 303, and the inverting amplifier circuit 304 perform the same processes as in the first embodiment. Hereinafter, the case where the input image data of red (R) is corrected will be described in detail.

### 2-2. Configuration of Image Processing Circuit

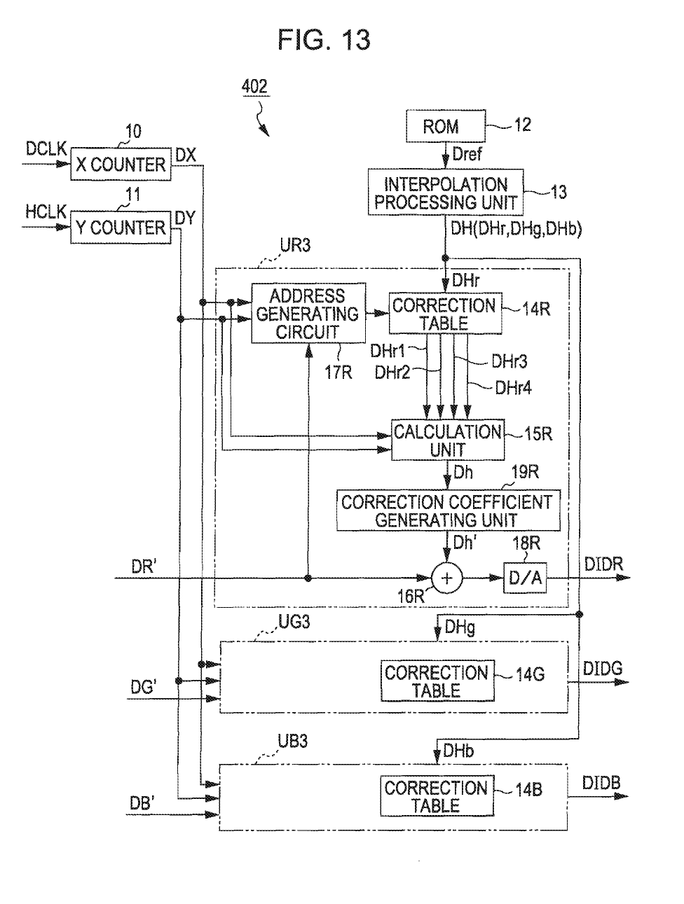

The configuration of a color non-uniformity correction circuit 402 included in an image processing circuit according to another embodiment of the invention will be described with reference to FIG. 13. FIG. 13 is a block diagram showing the configuration of the color non-uniformity correction circuit 402.

In FIG. 13, the color non-uniformity correction circuit 402 includes a ROM 12, an interpolation processing unit 13, an X counter 10, a Y counter 11, and correction units UR3, UG3, and UB3. The correction unit UR3 includes an address generating circuit 17R, a correction table 14R, a calculation unit 15R, a correction coefficient generation unit 19R, an adding unit 16R, and a D/A converter 18R. The ROM 12 and the interpolation processing unit 13, and the correction table 14R, the address generating circuit 17R, and the calculation unit 15R form an example of the first correction circuit. The correction coefficient generation unit 19R is an example of the second correction circuit.

The memory 12 is an example of the reference correction data storage circuit and stores reference correction data for correcting input image data DR′, to be described later, for each of a plurality of sets of reference coordinates. The reference coordinates means the same as described in the first embodiment. The interpolation processing unit 13 is an example of the first correction data generating circuit. The interpolation processing unit generates first correction data corresponding to each level of the input image data DR′ for each set of coordinates by performing an interpolation process on the reference correction data for the gradation level of the input image data. The correction table 14R is an example of the first correction data storage circuit and stores the first correction data generated by the interpolation processing unit 13 in correspondence with the reference coordinates and the level. The calculation unit 15R serves as both the selection circuit and the correction data generating circuit. The calculation unit selects a first correction data piece from the first correction data stored in the correction table 14R that corresponds to a plurality of sets of reference coordinates in the display area 103 positioned in proximity of the coordinates given by the address information and the level of the input image data DR′. To be more specific, the calculation unit 15R selects the first correction data pieces DHr1, DHr2, DHr3, and DHr4 from the correction table 14R on the basis of the address information of a pixel corresponding to the input image data DR′ determined on the basis of the address information supplied from the address generating circuit 17R, that is, the clock signals DCLK and HCLK.

The correction coefficient generating unit 19R is an example of the second correction circuit and generates correction data Dh′ by multiplying the correction data Dh output from the calculation unit 15R by a correction coefficient. The adding unit 16R adds the correction data Dh′ to the input image data DR′. The input image data DR′ corrected on the basis of the correction data Dh′ is converted into an analog signal by the D/A converter 18R to be output as an image signal VIDR.

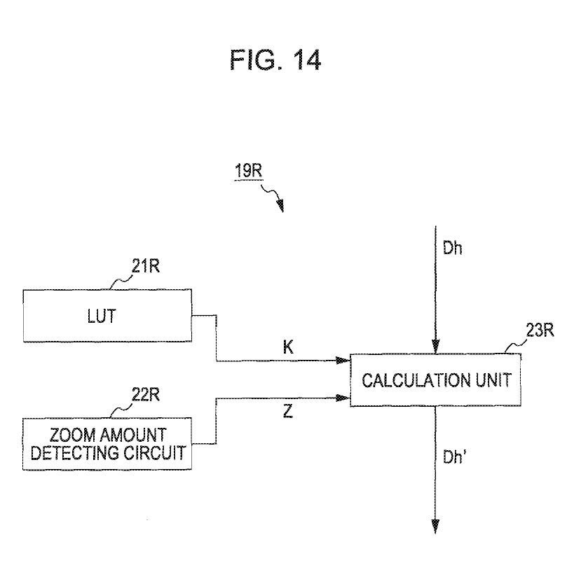

Next, the configuration of the correction coefficient generating unit 19R will be described with reference to FIG. 14. FIG. 14 is a block diagram showing the configuration of the correction coefficient generating unit 19R. In FIG. 14, the correction coefficient generating unit 19R includes a lookup table (LUT) 21R, a zoom amount detecting circuit 22R, and a calculation unit 23R.

The LUT 21R stores a correction coefficient K for reducing the color non-uniformity occurring due to the size of a projection image that is projected on the screen corresponding to the input image data DR′. The zoom amount detecting circuit 22R detects the zoom amount of the projection lens 1114. The calculation unit 23R detects the zoom amount of the projection lens 1114 from the zoom amount detecting circuit 22R, that is, the size of the projection image and reads out a correction coefficient corresponding to the size from the LUT 21R and multiplies the correction data Dh by the correction coefficient. Accordingly, the correction data Dh′ that can be used for reducing the color non-uniformity occurring due to the size of a projection image is generated. The adding unit 16R corrects the input image data DR′ by adding the correction data Dh′ to the input image data DR′. For the input image data corresponding to green (G) and blue (B), the same process is performed, thereby the color non-uniformity of the projection image is reduced. In addition, since the correction data that can be used for reducing the color non-uniformity is generated by multiplying the correction data Dh by the correction coefficient K, the correction data can be corrected at a high speed without individually storing the correction data corresponding to the size of the projection image in the memory 12 in advance. By using the correction data, the input image data can be corrected at a high speed.

### 2-3: Image Processing Method

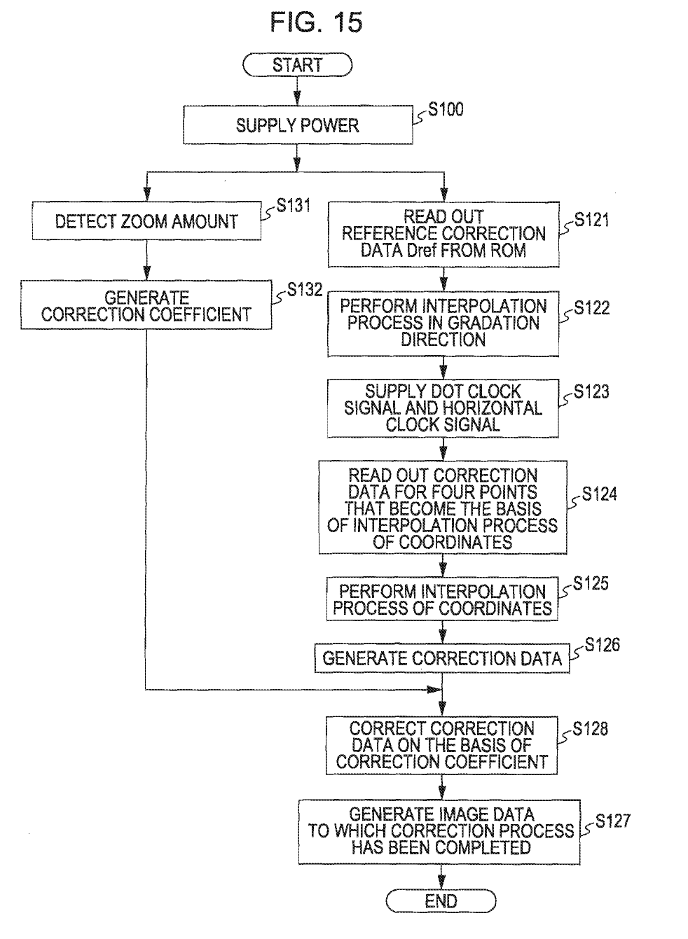

Next, an image processing method performed in the projector 1400 will be described with reference to FIG. 15. FIG. 15 is a flowchart showing the image processing method according to another embodiment of the invention. Here, only the operation for the correction of the color non-uniformity corresponding to R is described, but the same operation is performed for the correction of the color non-uniformity corresponding to B and G.

At first, when the power is supplied to the projector 1100 (step S100), the zoom amount detecting circuit 22R detects the zoom amount of the projection lens 1114 in a status that the projector 1400 can project a projection image on the screen (step S131). The calculation unit 313 detects the zoom amount from the zoom amount detecting circuit 22R and generates a correction coefficient K corresponding to the read zoom amount on the basis of the data read-out from the memory 21R (step S132). The operations of the steps S121 to S126 are performed, as in the first embodiment, simultaneously with the operations of the steps S131 and S132 or before/after the operations of the steps S131 and S132, whereby the correction data Dh is corrected on the basis of the correction coefficient K (step S128). Thereafter, the adding unit 16R generates input image data to which the correction process has been completed by adding the corrected correction data Dh′ to the input image data DR′ (step S127). The input image data corrected as described above is converted from digital data to analog data by the D/A converter 18R to be output.

By using the above-described method, the correction data Dh is corrected on the basis of the correction coefficient K only, and accordingly, the correction data can be corrected at a high speed, whereby the color non-uniformity occurring due to the size of a projection image can be effectively reduced.

What is claimed is:

1. An electro-optical device in which an image to be projected on a projection surface as a projection image having a size changed by a display device is displayed on a display area on the basis of input image data, the electro-optical device comprising:
a first input image correction circuit that (1) generates first correction data based on the size of the projection image and first reference correction data and (2) corrects the input image data using the generated first correction data; and
a second input image correction circuit that (1) corrects the input image data corrected by the first input image correction circuit based on a plurality of second reference correction data corresponding to a plurality of specific levels among preset input image data levels or for each set of a plurality of sets of reference coordinates in the display area.

2. The electro-optical device according to claim 1,
the display device being a projection-type display device including a zoom function for changing the size of the projection image; and
the first input image correction circuit comprising:
a zoom amount detecting circuit that detects a zoom amount of the zoom function of the display device;
a first reference correction data storage circuit that stores a plurality of the first reference correction data, the first reference correction data being set to correspond to a plurality of specific zoom amounts among the zoom amounts;
a first correction data generating circuit that generates the first correction data by interpolating the plurality of the first reference correction data in accordance with the detected zoom amount; and
a first correction data adding circuit that adds the first correction data to the input image data.

3. The electo-optical device according to claim 2,
the first reference correction data storage circuit storing the first reference correction data for (1) each of the plurality of specific levels of the input image data or (2) for each set of reference coordinates, and
the first correction data generating circuit interpolating the plurality of first reference correction data among (1) the specific levels that are different from each other or (2) the sets of reference coordinates that are different from each other.

4. The electro-optical device according to claim 1, the second correction circuit comprising:
a second reference correction data storage circuit that stores the second reference correction data for each set of reference coordinates;
a second correction data generating circuit that generates second correction data corresponding to each level by performing an interpolation process for the levels of the second reference correction data for each set of reference coordinates;
a second correction data storage circuit that stores second correction data in correspondence with a set of reference coordinates and a level of the plurality of levels;
a second correction data selecting circuit that selects a second correction data among the second correction data stored in the second correction data storage circuit that corresponds to a plurality of sets of reference coordinates positioned in proximity to a set of coordinates determined based on address information in the display area and the level;
a third correction data generating circuit that generates third correction data corresponding to the input image data by interpolating the coordinates of the second correction data selected by the second correction data selecting circuit; and
a third correction data adding circuit that adds the third correction data to the corrected input image data.

5. An electro-optical device in which an image to be projected on a projection surface as a projection image having a size than can be changed is displayed in a display area on the basis of input image data, the electro-optical device comprising:
a first correction circuit that (1) generates correction data for reducing color non-uniformity of the projection image based on a plurality of reference correction data that correspond to a plurality of predetermined input image data levels and each set of a plurality of sets of reference coordinates in the display area; and
a second correction circuit that corrects the correction data based on a correction coefficient that is set based on a change in the size of the projection image.

6. The electro-optical device according to claim 5, the first correction circuit comprising:
a reference correction data storage circuit that stores the reference correction data for each set of reference coordinates;
a first correction data generating circuit that generates first correction data corresponding to levels of the reference correction data by performing an interpolation process for the levels of the reference correction data for each set of reference coordinates;
a first correction data storage circuit that stores the first correction data in correspondence with a set of reference coordinates and a level,
a selection circuit that selects a first correction data piece among the first correction data stored in the first correction data storage circuit which corresponds to a plurality of sets of reference coordinates positioned near a set of coordinates determined on the basis of address information in the display area and the level; and
a correction data generating circuit that generates the correction data by interpolating the set of coordinates of the first correction data piece selected by the selection circuit.

7. An image processing circuit for reducing color non-uniformity of a projection image which occurs on the basis of a change in the size of the projection image at a time when an image displayed in a display area of an electro-optical device is projected on a projection surface as the projection image, the image processing circuit comprising:
a first input image correction circuit that generates first correction data, based on the size of the projection image and that corrects the input image data using the generated first correction data; and
a second input image correction circuit that corrects the corrected input image data based on a plurality of second reference correction data that correspond to a plurality of specific levels among levels that the input image data can have or corresponding to each set of a plurality of sets of reference coordinates in the display area.

8. An image processing circuit for reducing color non-uniformity of a projection image based on a change in the size of the projection image at a time when an image displayed in a display area of an electro-optical device is projected on a projection surface as the projection image, the image processing circuit comprising:
a first correction circuit that generates correction data for reducing color non-uniformity of the projection image based on a plurality of reference correction data that correspond to a plurality of specific predetermined input image data levels and for each set respectively of a plurality of sets of reference coordinates in the display area; and
a second correction circuit that corrects the correction data based on a correction coefficient that is set in accordance with the size change.

9. An image processing method of reducing color non-uniformity of a projection image which occurs based on a change in the size of the projection image at a time when an image displayed in a display area of an electro-optical device is projected on a projection surface as the projection image, the image processing method comprising:
generating first correction data, based on the size of the projection image
correcting the input image data using the generated first correction data; and
correcting the corrected input image data based on a plurality of second reference correction data that correspond to a plurality of specific predetermined input image data levels and for each set respectively of a plurality of sets of reference coordinates in the display area.

10. An image processing method for reducing color non-uniformity of a projection image which occurs based on a change in the size of the projection image at a time when an image displayed in a display area of an electro-optical device is projected on a projection surface as the projection image, the image processing method comprising:
generating correction data for reducing color non-uniformity of the projection image based on a plurality of reference correction data that corresponds respectively to a plurality of specific levels among predetermined input image data levels and each set respectively of a plurality of sets of reference coordinates in the display area; and
correcting the correction data based on a correction coefficient that is set in accordance with the size change.

11. An electronic device comprising:
a housing; and
an electro-optical device according to claim 1 positioned within the housing.

12. A projection-type display device comprising:
a housing; and
an electro-optical device according to claim 2 positioned within the housing.

13. An image processing circuit, comprising:
a first color correction circuit that receives input image data, the first color correction circuit including:
a zoom amount detecting circuit that detects a detected zoom amount of the projection lens; and
a first correction unit that (1) calculates first correction data based on a reference data set and the detected zoom amount, and (2) adds the first correction data to the input image data to generate an updated correction data; and
a second color correction circuit that receives the updated correction data, the second color correction circuit including
an interpolation processing circuit that generates a coordinate correction data piece based on a reference coordinate correction data set; and
a second correction unit that (1) generates second correction data based on the coordinate correction data piece, (2) adds the second correction data to the updated correction data to generate color non-uniformity correction data.
